(19) United States
(12) Patent Application Publication
(10) Pub. No.: US 2013/0191186 A1
(43) Pub. Date: Jul. 25, 2013

(54) SYSTEM, METHOD AND COMPUTER PROGRAM FOR CAPTURING RELATIONSHIPS BETWEEN BUSINESS OUTCOMES, PERSONS AND TECHNICAL ASSETS

(71) Applicant: International Business Machines Corporation, Armonk, NY (US)

(72) Inventors: Heiko Ludwig, San Francisco, CA (US); Rakesh Mohan, Cortlandt Manor, NY (US); Ajay Mohindra, Yorktown Heights, NY (US); Yuhichi Nakamura, Tokyo (JP); Mahmoud Naghshineh, Hopewell Junction, NY (US); Bikram Sengupta, Bangalore (IN)

(73) Assignee: International Business Machines Corporation, Armonk, NY (US)

(21) Appl. No.: 13/723,280

(22) Filed: Dec. 21, 2012

Related U.S. Application Data
(60) Provisional application No. 61/589,962, filed on Jan. 24, 2012.

(51) Int. Cl. G06Q 10/06

(52) U.S. Cl. CPC G06Q 10/06393
USPC 705/7.39

(57) ABSTRACT

A method includes building a library of service value maps (SVMs) each including a multi-layered hierarchical arrangement of elements with causal links between at least some elements of a particular layer and at least some elements of next higher layer. Each SVM includes at a topmost layer at least one desired outcome for an entity associated with the SVM, at a next lower layer capabilities that support the at least one desired outcome and, for each identified capability, at a next lower layer organization solution assets that support the capabilities. The identified solution assets and components are mapped to infrastructure elements in a lower-most layer. The method further includes assigning weights to the links between elements of a particular layer and elements of a next higher layer, where each weight has a value to indicate a contribution of an associated element to a linked-to element in the next higher layer.

### CLAIM OF PRIORITY FROM COPENDING PROVISIONAL PATENT APPLICATION

This patent application claims priority under 35 U.S.C. §119(e) from Provisional Patent Application No. 61/589,962, filed Jan. 24, 2012, the disclosure of which is incorporated by reference herein in its entirety.

### TECHNICAL FIELD

The exemplary embodiments of this invention relate generally to methods, data processing systems and computer software and computer-readable mediums that contain computer software configured and adapted for at least one or more of determining causality links, determining information technology (IT) outcomes, determining business (enterprise) outcomes and, even more generally, to enterprise architectures and to techniques that operate with a component business model (CBM).

### BACKGROUND

General reference may be had to the following commonly assigned US Patent Applications: US 2010/0250300 A1, Method for Transforming an Enterprise Based on Linkages Among Business Components, Business Processes and Services, Antoun et al.; US 2010/0107135 A1, System and Method for Transforming a Component Business Model, Arsanjani et al.; US 2009/0018879 A1, Method and System Supporting Business Solution Validation in a Component Business Model, Flaxer et al.; and US 2008/0215398 A1,System And Method for Using a Component Business Model to Manage an Enterprise, Cohn et al.

The above referenced US 2010/0107135 A1 defines a CBM as a model of a business including a plurality of non-overlapping business components representing a target state of the business, with each component being a group of cohesive business activities. Preferably the CBM includes the following elements: (i) Business Components element; (ii) Business Competency element; and/or (iii) Business Service element and/or (iv) Business Activity element. The CBM can include a heat map defined as a set of data identifying at least one critical business component(s) in a CBM, without regard to: (i) whether the heat map assigns a priority value to all components; (ii) the number of possible priority values used in the heat map; and/or (iii) the criteria and/or manner by which critical components are selected.

Enterprises are primary concerned with achieving key (i.e., significant and/or important) business outcomes. Business outcomes may be defined as outcomes that focus on factors that impact the business performance such as revenue, cost, and profit. Some examples of business outcomes are metrics such as increasing sales, reducing the cost of customer acquisition, reducing customer chum, etc. In contrast, service providers are concerned with delivering and measuring IT outcomes delivered through some set of IT services. IT outcomes may be defined as outcomes that focus only on the performance of information technology related metrics such as cost, utilization and management of IT resources. Some examples of IT outcomes are mean-time-between-failures of servers at a data center, average server utilization, average storage utilization, service level agreements, and/or the number of server per system administrator.

These two goals may, in certain situations, not overlap to any significant extent.

### SUMMARY

In a first aspect thereof the exemplary embodiments of this invention provide a computer-implemented method that includes building a library of service value maps, where each service value map comprises a multi-layered hierarchical arrangement of elements comprising causal links between at least some elements of a particular layer and at least some elements of next higher layer. Each service value map comprises at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome. The identified solution assets and components are mapped to specific infrastructure elements in a lower-most layer of the hierarchical arrangement of elements of the service value map. The method further comprises assigning weights to the links between elements of a particular layer of the service value map and elements of a next higher layer, where each weight has a value to indicate a contribution of an associated element at the particular layer to a linked-to element in the next higher layer.

In a further aspect thereof the embodiments of this invention provide a computer-readable data storage medium that stores a data structure representing a service value map comprised as a multi-layered hierarchical arrangement of elements and causal links between at least some elements of a particular layer and at least some elements of next higher layer. The service value map comprises at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map. In the data structure the causal links each have an associated weight having a value to indicate a contribution of an associated element at the particular layer to a linked-to element in the next higher layer.

In a still further aspect thereof the embodiments of this invention provide a computer-readable data storage medium that stores program code representing a computer program that is executable by at least one data processor. Execution of the computer program comprises operations of building a library of service value maps, each service value map comprising a multi-layered hierarchical arrangement of elements comprising causal links between at least some elements of a particular layer and at least some elements of next higher layer, each service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map; and assigning weights to the links between elements of a particular layer of the service value map and elements of a next higher layer, each weight having a value to indicate a contribution of an associated element at the particular layer to a linked-to element in the next higher layer.

In yet another aspect thereof the embodiments of this invention provide a data processing system that comprises at least one data processor connected with at least one computer-readable medium that stores program code that is executable by the at least one data processor. The at least one computer-readable medium also stores at least one service value map comprising a multi-layered hierarchical arrangement of elements having causal links between at least some elements of a particular layer and at least some elements of next higher layer, the at least one service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map; where weights are assigned to the links between elements of a particular layer of the service value map and elements of a next higher layer, each weight having a value to indicate a contribution of an associated element at the particular layer to a linked-to element in the next higher layer.

### BRIEF DESCRIPTION OF THE SEVERAL VIEWS OF THE DRAWINGS

FIG. 1 shows a non-limiting example of a hierarchical Service Value Map (SVM) in accordance with an aspect of this invention.

FIG. 2 shows an example of a SVM schema composed of an Enterprise Architecture (EA) hierarchy arranged, by example, as Infrastructure, Solution, Capability and Outcome layers, and also shows a key performance indicator (KPI) tree having KPI elements that are linked to at least some elements of the SVM and to one another.

FIG. 3 shows an exemplary block diagram of a system that is suitable for implementing the embodiments of this invention.

FIG. 4 is a logic flow diagram that depicts method steps in accordance with embodiments of this invention, as well as a result of execution of computer software stored in a memory shown in FIG. 3.

FIG. 5 is a logic flow diagram that is descriptive of an embodiment of a process for creating a Service Value Map such as the non-limiting examples of the Service Value Maps shown in FIGS. 1 and 2.

### DETAILED DESCRIPTION

To be successful in a competitive marketplace it would be desirable for Service providers to be capable of relating proposed and/or provided IT assets to key business outcomes of an Enterprise (e.g., a client of the Service provider), and to express using some readily understood metric or metrics a degree of contribution that each IT asset makes towards achieving a desired business outcome of an Enterprise.

The examples of the embodiments of this invention provide a computer-implemented methodology and system to create and represent Service Value Maps (SVMs) that capture and represent relationships among various outcomes to underlying technology assets. In accordance with a method this is accomplished by building a library of known industry-specific business outcomes for various organizations of interest; identifying key business capabilities that support each business outcome; for each identified business capability, identifying key processes and activities that support the business outcomes; and for each key process and activity, identifying solution assets and components that contribute towards the business outcomes. The identified solution assets and components are then mapped to specific infrastructure elements. Linkages between the identified solution assets and components are assigned weights to indicate how much each asset and component contributes as a percentage to the business outcomes.

The library of SVMs that has been created for different industries and different clients within an industry enables analysis and reuse of SVMs.

Non-limiting examples of an ‘organization’ that can benefit from the use of the embodiments of this invention include, but are not limited to, wired and wireless telecommunications businesses, for-profit and not-for-profit healthcare businesses, charities, government agencies, banking institutions, financial/mortgage institutions, retailers of various consumer goods, manufacturers of various products including consumer goods and components used to fabricate consumer goods, and suppliers of goods and/or services of a military/defense nature.

As used herein an ‘entity’ can be any organization (for-profit or not-for-profit) such as a business, a charity or a government agency.

As used herein a reference to a ‘Business Outcome’ can be broadly construed to mean any ‘desired outcome’ of an entity or organization, e.g., increasing sales, reducing cost, increasing an amount of charitable contributions, expanding a customer/subscriber base, reducing customer chum (increasing customer retention), loss mitigation, fraud detection, reducing time required to launch a new product, reduce out-of-stock incidents at retail outlets, etc. A desired Business Outcome may be considered as a business ‘Goal’. A Business Outcome may be measured by Key Performance Indicators (KPIs), such as: reduce customer chum<20%, or reduce fraudulent claims to <5%, etc.

As employed herein the Component Business Model (CBM) can be considered to represent business components, competencies and decision framework(s). An Enterprise Architecture (EA) can be considered to represent a mechanism and process for translating business goals and strategies into effective enterprise change by creating, communicating and improving key requirements, principles and models that describe a future state of the Enterprise and enable the evolution of the Enterprise from a current state to the desired future state. The embodiments of this invention focus at least in part on the contribution level of a capability to the overall desired business outcome. The embodiments of this invention extend a conventional CBM concept by adding the values (weights) to the relationships between components and capabilities, and supporting assets.

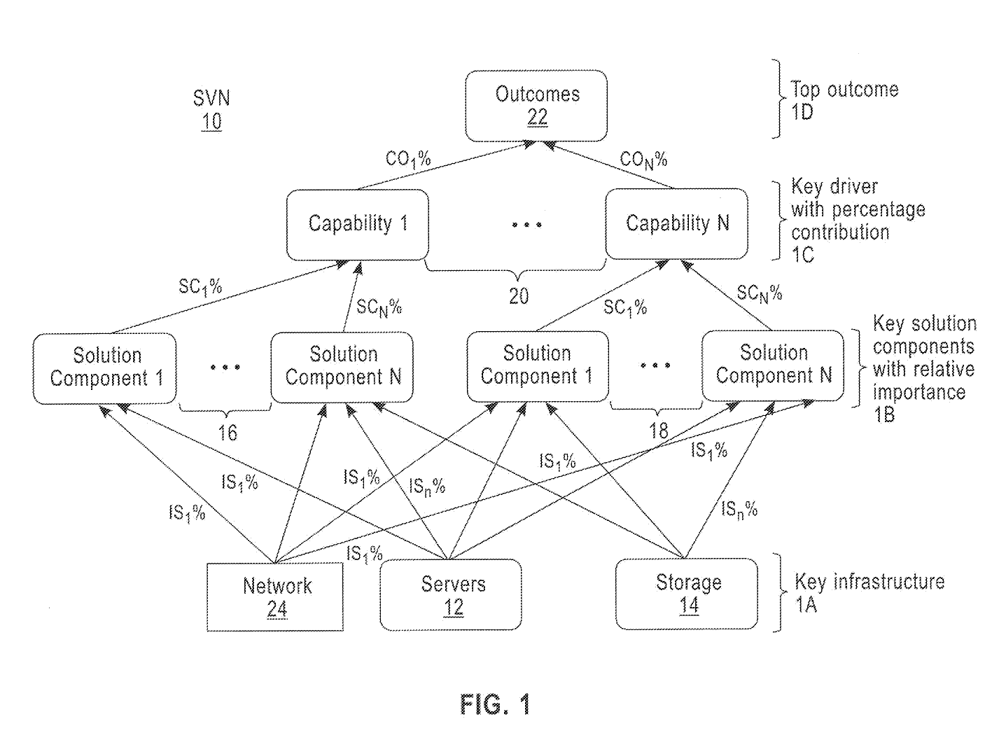

FIG. 1 shows a non-limiting example of a hierarchical Service Value Map (SVM) 10 in accordance with an aspect of this invention. The SVM 10 includes a number of elements. A first level 1A (Level₁) includes Key Infrastructure elements such as servers 12, network 24 and storage 14. The first level 1A can also include, as non-limiting examples, software such as an operating system or operating systems, middleware, and database management systems. The first level 1A can also include, depending on the nature of the business, a data center, a call center, a contact center, and/or a help-desk. The Infrastructure layer 1A can generally include any hardware/software/network(s) and associated support hardware/software/network(s) and personnel needed by an associated entity to function and interact with customers/clients/contributors/subscribers, etc.

A second level 1B (Level₂) contains key Solution component elements with their relative importance. In this example there are two Solution component elements 16 and 18 each comprising some number (e.g., N) of sub-components. The Solution component elements 16 and 18 could also be referred to as Business Services such as customer relationship management (CRM), billing, and order management.

A third level 1C (Level₃) contains key driver elements 20 including Capability 1 through Capability N, such as sales, order handling, customer quality of service, billing and collections management, billing inquiries, etc., each of which makes some percentage contribution (CO %) in a linkage (L) to a final (top) Outcome(s) element 22 at a fourth level 1D (Level₄) of the SVM 10. Capabilities or Business capabilities may be defined as what a business does, such as the services it provides to customers, or the operational functions it performs for employees. Note that each element of the SVM 10 could be further decomposed into more detailed constituent elements.

In general, business outcomes 22 are enabled by the business capabilities 20 (e.g., retention, customer lifecycle management, etc.), which in turn are enabled by the business services and solutions 16, 18, which in turn are enabled by the key infrastructure layer 1A that ideally supports flexible, reliable and secure infrastructure services to all of the overlying layers of the entity.

An aspect of this invention is the linkage (L) or linkages between the elements shown in FIG. 1. Each linkage (causal link), which can also be referred to without a loss of generality as an ‘edge’, is assigned a weight (expressed in a non-limiting example as a percentage %) to indicate how much the element from which the linkage originates contributes to an element or elements at a next higher level of the hierarchy. For example, in the SVM 10 the Servers infrastructure element 12 and the Network infrastructure element 24 each has an Infrastructure (IS) linkage to each of the overlying Solution component and sub-component elements 16 and 18, while the Storage infrastructure element 14 has IS linkages to some but not all of the overlying Solution component and sub-component elements 16 and 18. In like manner each of the Solution component and sub-component elements 16 and 18 has a linkage SC to the overlying Capability elements 20 that in turn have the above-mentioned CO linkages to the final (top) Outcome(s) 22. The weight assigned to each linkage can represent one or more attributes such as, for example, cost, contribution, price and/or a condition or conditions imposed by a service level agreement or agreements. The linkages and their associated weights can be considered as quantitatively indicating a contribution of a given element to an element higher in the hierarchy and, eventually, to the desired business outcome 22. The computation of a percentage weight for each link is a function of the attributes associated with the component in the SVM from which the link originates.

The Service Value Map 10 beneficially provides complete “line of sight” visibility from business outcomes to key technology and solution assets. The Service Value Map 10 also provides a framework for service providers to understand the technology and solution choices to deliver business based on the weights assigned to each edge of the SVM 10. The Service Value Map 10 further enables a client to understand how technology contributes to achieving business outcomes.

The SVM 10 may be considered to represent an industry-specific teardown of business outcomes at all levels of the hierarchical stack, with causal links between the elements of the SVM. The SVM 10 provides insight into key enablers for value and can identify value aggregation points through analysis. The causality links between elements across the layers of the SVM 10 can indicate by the strength of relationships between elements first order key drivers and can enable identification of high value assets. The various elements in the SVM 10 specify key attributes and metrics and characterize key high value assets and service specifications. The SVM 10 provides a structure to run analytics on to identify key nodes in a graph that are key enablers of an outcome. These key enablers can be enhanced as high value assets that are high percentage contributors to the outcome(s).

It can be noted that some business capabilities can be identified that are common across some or all industries (e.g., customer churn management). The value aggregation points and high value assets for these business capabilities can then be identified in specific industries (e.g., airline, healthcare, telecommunications, retail, etc.) with industry-specific analytics. Next an optimization can be performed across the layers 1A-1D of the SVM 10 to tune the solutions and IT services together to deliver the maximum benefit to the client.

The embodiments of this invention provide a method and structure to represent business outcomes, where an outcome is linked to a set of supporting business capabilities; where each business capability is linked to a set of enabling solutions; where each solution is linked to a set of required infrastructure elements; and where each linkage between elements in a hierarchical arrangement of elements is assigned a weight that represents one or a plurality of attributes such as cost, contribution, price and service level agreements (SLAs).

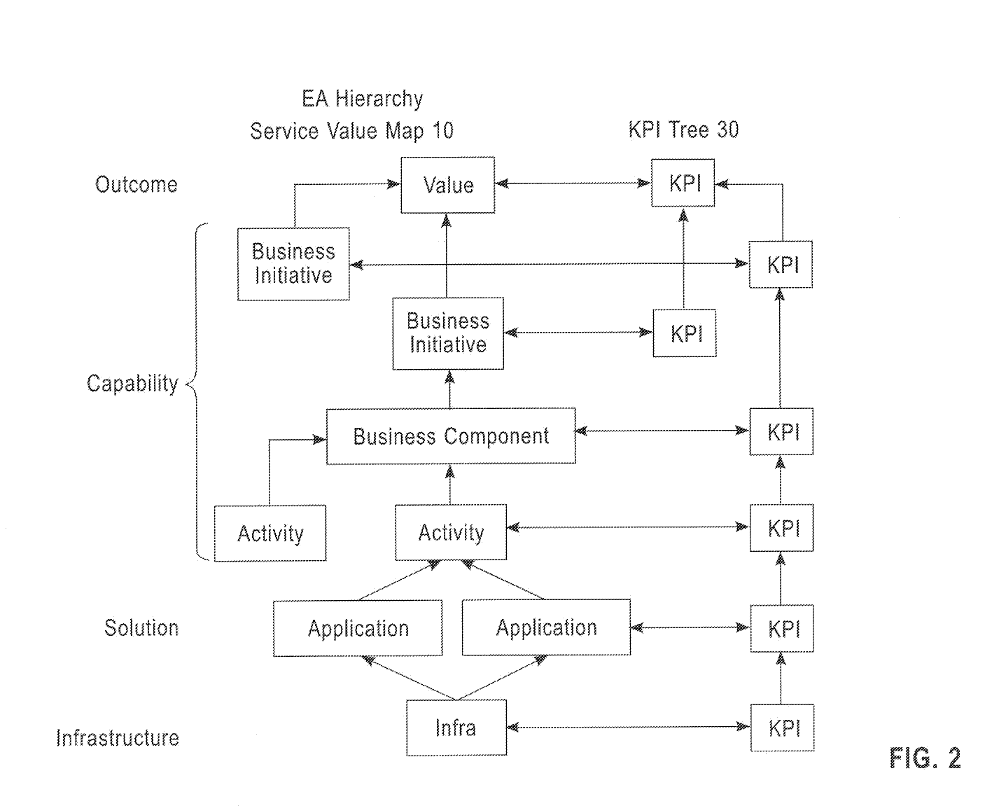

FIG. 2 shows an example of a Service Value Map schema composed of an Enterprise Architecture (EA) hierarchy arranged by example as Infrastructure 1A, Solution 1B, Capability 1C and Outcome 1D. In this example the Capability layer 1C includes a sub-hierarchy composed of elements: Activity, Business Component, and Business Initiative. The EA hierarchy in accordance with an aspect of this invention defines the causal relationships (the weighted linkages shown in FIG. 1) between Business and IT elements so as to explicitly represent how the IT elements contribute to the Business Outcome(s). In the SVM schema there is also a KPI tree 30 having KPI elements that are linked to at least some elements of the SVM 10 and to one another. A KPI is calculated using child nodes. The EA hierarchy (SVM 10) is mapped onto the KPIs by a one-to-one mapping or a many-to-many mapping as appropriate. For example, a KPI S_{F} that measures the direct cost of frauds due to churns and operation cost is a function of three other KPIs: (1) % of churners due to fraudulent cases out of total number of churns P_{CPF}, (2) cost of helpdesk and inquiry per complaint C_{C}, and (3) average cost of bill adjustment per fraudulent case C_{B} We can express S_{F} as

S_{F}=(P_{CF}/100)*C_{R}/100)*T_{P}*ARPU+(C_{C}+C_{B})*N_{F}

### Where

C_{R}=Total churn rate
T_{P}=Total number of subscribers
N_{F}=Number of frauds reported
ARPU=Average Revenue Per User
   A service value map also represents a mathematical model that can be used to perform a what-if analysis. For example, when cost estimation can be used to extend the SVM 10, e.g., by defining a cost/KPI variation (best/worst/most likely) to each task, e.g., if x dollars are spent for task y for the best case, then KPI z can be improved by 5% as compared to the most likely case). Then a best solution can be selected considering the cost and outcome for each case.

Traditional tools in the prior-art implement only a subset of the capability offered by Service Value Maps in accordance with the embodiments of this invention. For example, Component Business Modeling (CBM) (http://www-935ibm.com/services/us/en/business-services/ibm-component-business-modeling-services-sm.html) identifies the basic building blocks of an enterprise as competencies that can be used to create a model of the essential business processes in the industry, using it to identify differentiating and non-differentiating components and isolate those presenting immediate opportunities for growth, innovation or improvement. A CBM does not extend its scope to the supporting solution and infrastructure components, and causality links between components. The Rational System Architect (http://www-01.ibm.com/software/awdtools/systemarchitect/) provides a platform for visualizing, analyzing and communicating an organization's enterprise architecture and business process analysis. Its scope does not extend to mapping the Enterprise architecture to supporting solution and infrastructure components, and causality links between components. In addition to the foregoing tools, the Rational Software Architect (http://www-01.ibm.com/software/awdtools/swarchitect/) provides integrated design and development support for model-driven development with the UML. Its scope is limited to development of solution components independent of business outcomes, capabilities, and infrastructure components. It also does not support any causality links between components.

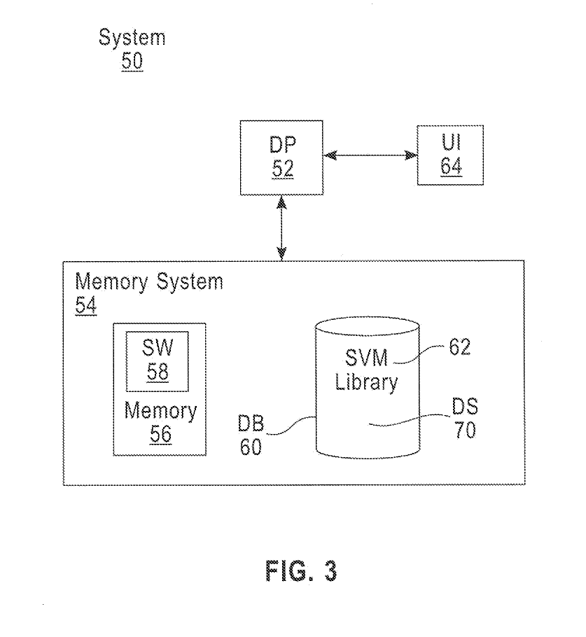

FIG. 3 shows an exemplary block diagram of a system 50 that is suitable for implementing the embodiments of this invention. The system 50 includes at least one data processor 52 connected with at least one computer-readable medium such as one embodied as a memory system 54. The memory system 54 can include a memory 56 storing computer program code implementing computer software (SW) 58 that, when executed by the data processor 52, results in the performance of methods in accordance with this invention. The memory system 54 also includes a database (DB) 60 that stores a library 62 of the SVMs 10. As was noted above the library 62 can be populated with SVMs 10 configured to represent one or more industries/organizations of interest. A user interface 64, such as a graphical user interface (GUI), is provided enabling a user of the system 50 to interact with the software 58 and the library 62 of SVMs 10 in order to open a particular SVM of interest and modify at least one or more of the linkage values between SVM elements in order to tune and optimize the SVM for a particular client in a particular industry/organization. Changes to a particular SVM 10 can be saved in the database 60 for possible reuse.

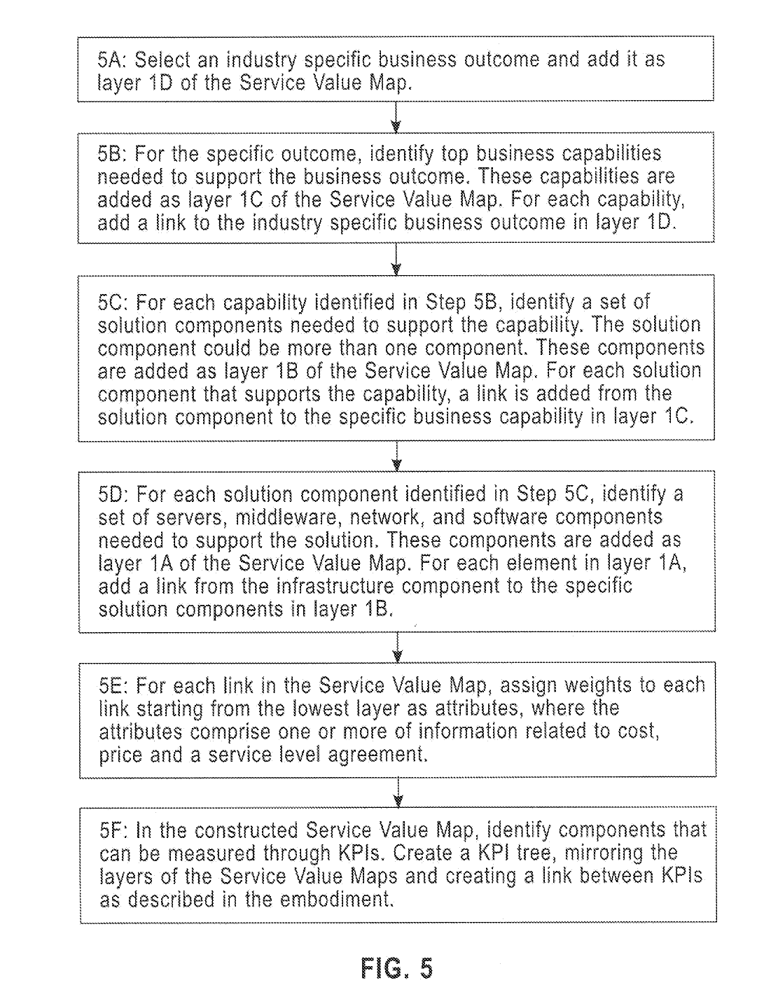

It should be appreciated that a given SVM 10 when stored in the computer-readable medium, such as the database 60, can be considered to represent a data structure (DS) 70 that is readable and possibly modifiable by the data processor 52. The creation of an SVM 10 is described in relation to FIG. 5.

The system 50 could implemented at single geographical location, such as one associated with a certain IT service provider, or it could be implemented and distributed over multiple locations and the components networked together by any suitable wired and/or wireless connections. In some embodiments the system 50 could be instantiated in whole or in part in a cloud computing environment.

While described herein primarily in the context of services provided by an IT service provider it should be appreciated that a given business/organization could utilize the teachings of this invention for their own purposes to achieve optimized Business Outcomes in the hierarchy that includes base level resident IT components/services of the business/organization.

That is, while the embodiments of this invention can be readily utilized to provide a service by one business for another business, these embodiments could also be utilized totally “in-house” to optimize Business Outcomes of a particular Enterprise.

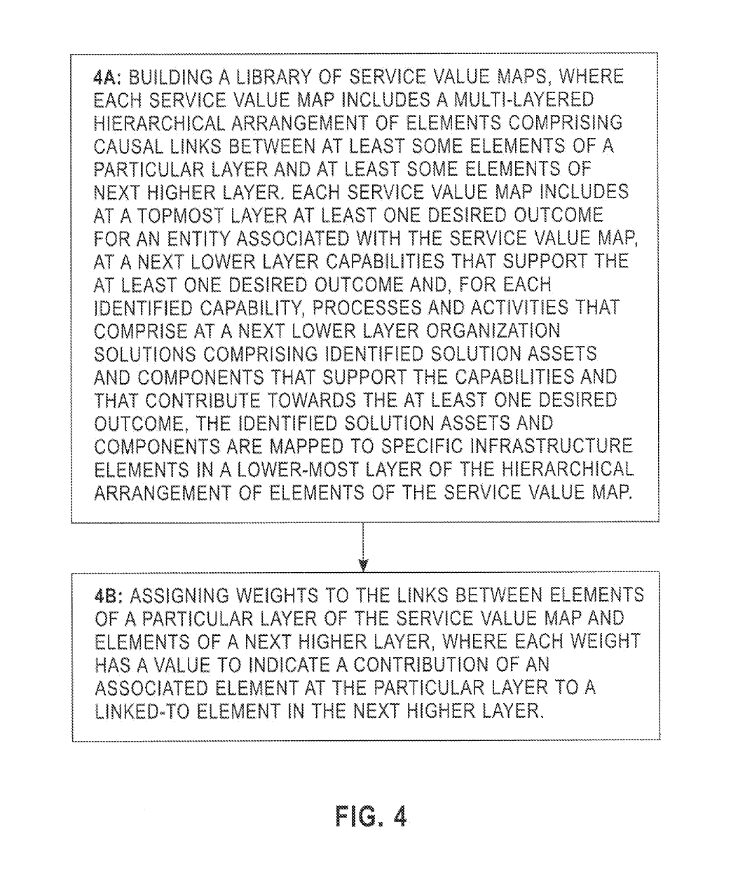

FIG. 4 is a logic flow diagram that depicts method steps in accordance with embodiments of this invention, as well as a result of execution of the software 58 stored in the memory 56 of FIG. 3.

The computer-implemented method includes at Block 4A a step of building a library of service value maps, where each service value map includes a multi-layered hierarchical arrangement of elements comprising causal links between at least some elements of a particular layer and at least some elements of next higher layer. Each service value map includes at a topmost layer at least one desired outcome for an entity associated with the service value map, at a next lower layer capabilities that support the at least one desired outcome and, for each identified capability, processes and activities that comprise at a next lower layer organization solutions that support the capabilities and, for each solution, assets and components that contribute towards the at least one desired outcome. The identified solution assets and components are mapped to specific infrastructure elements in a lower-most layer of the hierarchical arrangement of elements of the service value map. The method further includes at Block 4B a step of assigning weights to the links between elements of a particular layer of the service value map and elements of a next higher layer, where each weight has a value to indicate a contribution of an associated element at the particular layer to a linked-to element in the next higher layer.

In the method depicted in FIG. 4 a weight has a value that indicates a percentage contribution of an associated element at the particular layer to a linked-to element in the next higher layer and is a function of at least one attribute of the associated element.

In the method depicted in FIG. 4 and in the previous paragraph where an attribute comprises information related to at least one or more of cost, price and a service level agreement.

In the method depicted in FIG. 4 there can be a further step of varying a value of a weight of least one link to determine an optimal service value map for a particular entity.

In the method depicted in FIG. 4 there can be a further step of varying a value of a weight of least one link to determine an optimal configuration of elements that comprise the infrastructure layer for a particular entity.

In the method depicted in FIG. 4, where a service value map comprises a part of a schema comprising a hierarchical arrangement of key performance indicator elements having links to at least some of the elements of the service value map.

In the method depicted in FIG. 4 there can be a further step of opening the library of service value maps and selecting a most appropriate service value map as an initial service value map for use with a particular entity.

The method of FIG. 4 is performed as a result of execution of computer program code stored in a computer-readable medium.

FIG. 5 is a logic diagram of a process for creating a Service Value Map further in accordance with the embodiments of this invention. In the step shown in Block 5A, the first step is to select an industry specific business outcome and add it as layer 1D of the Service Value Map. Next in Block 5B, for the specific outcome, identify top business capabilities needed to support the business outcome. These capabilities are added as layer 1C of the Service Value Map. For each capability, add a link to the industry specific business outcome in layer 1D. In Block 5C, for each capability identified in Step 5B, identify a set of solution components needed to support the capability. The solution component could be more than one component. These components are added as layer 1B of the Service Value Map. For each solution component that supports the capability, a link is added from the solution component to the specific business capability in layer 1C. In Block 5D, for each solution component identified in Block 5C, identify a set of infrastructure components such as servers, middleware, network, and software components needed to support the solution. These components are added as layer 1A of the Service Value Map. For each element in layer 1A, add a link from the infrastructure component to the specific solution components in layer 1B.

In Block 5E, for each link in the Service Value Map, assign weights to each link starting from the lowest layer as attributes, where the attributes comprise one or more of information related to cost, price and a service level agreement.

In Block 5F, in the constructed Service Value Map, identify components that can be measured through KPIs. Create a KPI tree, mirroring the layers of the Service Value Maps, and creating links between KPIs as described earlier.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a ‘circuit’, a ‘module’ or a ‘system’. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a single local computer, partly on the local computer, as a stand-alone software package, partly on the local computer and partly on a remote computer or entirely on the remote computer or server. In the latter scenario, the remote computer may be connected to the local computer through any type of network, including a LAN or a WAN, or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perfoiiu the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent mathematical expressions may be used by those skilled in the art. However, all such and similar modifications of the teachings of this invention will still fall within the scope of this invention.

What is claimed is:

1. A computer-implemented method, comprising:
building a library of service value maps, each service value map comprising a multi-layered hierarchical arrangement of elements comprising causal links between at least some elements of a particular layer and at least some elements of next higher layer, each service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map; and
assigning weights to the links between elements of a particular layer of the service value map and elements of a next higher layer, each weight having a value to indicate a contribution of an associated element at the particular layer to a linked-to element in the next higher layer.

2. The method of claim 1, where a weight value indicates a percentage contribution of an associated element at the particular layer to a linked-to element in the next higher layer and is a function of at least one attribute of the associated element.

3. The method of claim 2, where an attribute comprises information related to at least one or more of cost, price and a service level agreement.

4. The method of claim 1, further comprising varying a value of a weight of least one link to determine an optimal service value map for a particular entity.

5. The method of claim 1, further comprising varying a value of a weight of least one link to determine an optimal configuration of elements that comprise the infrastructure layer for a particular entity.

6. The method of claim 1, where a service value map comprises a part of a schema comprising a hierarchical arrangement of key performance indicator elements having links to at least some of the elements of the service value map.

7. The method of claim 1, further comprising opening the library of service value maps and selecting a most appropriate service value map as an initial service value map for use with a particular entity.

8. The method of claim 1, performed as a result of execution of computer program code stored in a computer-readable medium.

9. The method of claim 1, where construction of a service value map comprises:
selecting an industry-specific business outcome to populate the topmost layer;
for the selected industry-specific business outcome identifying business capabilities to populate the next lower layer, the identified business capabilities being those needed to support the selected industry-specific business outcome and adding a link to the industry-specific business outcome in the topmost layer;
for each identified business capability identifying a set of solution components to populate the next lower layer, the identified solution components being those needed to support the identified business capability and adding a link from the identified solution component to the identified business capability;
for each solution component identifying a set of infrastructure components to populate the lower-most layer of the hierarchical arrangement of elements of the service value map and adding a link from each infrastructure component to the identified solution components;
for each link in the service value map, assigning a weight to each link starting from the lower-most layer, each weight representing attributes comprised of one or more of information related at least to cost, price and a service level agreement; and
identifying components of the service value map that can be measured using key performance indicators, creating a tree of key performance indicators having layers that mirror the layers of the service value map, and creating links between the key performance indicators.

10. A computer-readable data storage medium that stores a data structure representing a service value map comprised as a multi-layered hierarchical arrangement of elements and causal links between at least some elements of a particular layer and at least some elements of next higher layer, the service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map, where the causal links each have an associated weight having a value to indicate a contribution of an associated element at the particular layer to a linked-to element in the next higher layer.

11. A computer-readable data storage medium that stores program code representing a computer program that is executable by at least one data processor, where execution of the computer program comprises operations of:
building a library of service value maps, each service value map comprising a multi-layered hierarchical arrangement of elements comprising causal links between at least some elements of a particular layer and at least some elements of next higher layer, each service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map; and
assigning weights to the links between elements of a particular layer of the service value map and elements of a next higher layer, each weight having a value to indicate a contribution of an associated element at the particular layer to a linked-to element in the next higher layer.

12. The computer-readable data storage medium of claim 11, where a weight value indicates a percentage contribution of an associated element at the particular layer to a linked-to element in the next higher layer and is a function of at least one attribute of the associated element.

13. The computer-readable data storage medium of claim 12, where an attribute comprises information related to at least one or more of cost, price and a service level agreement.

14. The computer-readable data storage medium of claim 11, further comprising an operation of varying a value of a weight of least one link to determine an optimal service value map for a particular entity.

15. The computer-readable data storage medium of claim 11, further comprising an operation of varying a value of a weight of least one link to determine an optimal configuration of elements that comprise the infrastructure layer for a particular entity.

16. The computer-readable data storage medium of claim 11, where a service value map comprises a part of a schema comprising a hierarchical arrangement of key performance indicator elements having links to at least some of the elements of the service value map.

17. The computer-readable data storage medium of claim 11, further comprising an operation of opening the library of service value maps and selecting a most appropriate service value map as an initial service value map for use with a particular entity.

18. The computer-readable data storage medium of claim 11, where construction of a service value map comprises operations of:
selecting an industry-specific business outcome to populate the topmost layer;
for the selected industry-specific business outcome identifying business capabilities to populate the next lower layer, the identified business capabilities being those needed to support the selected industry-specific business outcome and adding a link to the industry-specific business outcome in the topmost layer;
for each identified business capability identifying a set of solution components to populate the next lower layer, the identified solution components being those needed to support the identified business capability and adding a link from the identified solution component to the identified business capability;
for each solution component identifying a set of infrastructure components to populate the lower-most layer of the hierarchical arrangement of elements of the service value map and adding a link from each infrastructure component to the identified solution components;
for each link in the service value map, assigning a weight to each link starting from the lower-most layer, each weight representing attributes comprised of one or more of information related at least to cost, price and a service level agreement; and
identifying components of the service value map that can be measured using key performance indicators, creating a tree of key performance indicators having layers that mirror the layers of the service value map, and creating links between the key performance indicators.

19. A data processing system comprising at least one data processor connected with at least one computer-readable medium that stores program code that is executable by the at least one data processor and that stores at least one service value map comprising a multi-layered hierarchical arrangement of elements having causal links between at least some elements of a particular layer and at least some elements of next higher layer, the at least one service value map comprising at a topmost layer at least one desired outcome for an entity associated with the service value map, at a next lower layer capabilities that support the at least one desired outcome and, for each identified capability, processes and activities that comprise at a next lower layer organization solutions comprising identified solution assets and components that support the capabilities and that contribute towards the at least one desired outcome, where the identified solution assets and components are mapped to specific infrastructure elements in a lower-most layer of the hierarchical arrangement of elements of the service value map; where weights are assigned to the links between elements of a particular layer of the service value map and elements of a next higher layer, each weight having a value to indicate a contribution of an associated element at the particular layer to a linked-to element in the next higher layer.

20. The system of claim 19, where a weight value indicates a percentage contribution of an associated element at the particular layer to a linked-to element in the next higher layer and is a function of at least one attribute of the associated element, where an attribute comprises information related to at least one or more of cost, price and a service level agreement.

21. The system of claim 19, where the at least one data processor when executing the computer program is enabled to vary a value of a weight of least one link to at least one of determine an optimal service value map for a particular entity and determine an optimal configuration of elements that comprise the infrastructure layer for a particular entity.

22. The system of claim 19, where the at least one service value map comprises a part of a schema comprising a hierarchical arrangement of key performance indicator elements having links to at least some of the elements of the service value map.

23. The system of claim 19, where the at least one data processor is connected with at least one computer-readable medium that stores a library of service value maps, and where the at least one data processor when executing the computer program is enabled to open the library and to select a most appropriate service value map as an initial service value map for use with a particular entity.
